(19) United States
(12) Patent Application Publication
(10) Pub. No.: US 2016/0239592 A1
(43) Pub. Date: Aug. 18, 2016

(54) DATA-DRIVEN BATTERY AGING MODEL USING STATISTICAL ANALYSIS AND ARTIFICIAL INTELLIGENCE

(71) Applicant: NEC Laboratories America, Inc., Princeton, NJ (US)

(72) Inventor: Seyyed Ali Pourmousavi Kani, San Jose, CA (US)

(21) Appl. No.: 15/015,377

(22) Filed: Feb. 4, 2016

Related U.S. Application Data
(60) Provisional application No. 62/219,895, filed on Sep. 17, 2015.
(60) Provisional application No. 62/115,258, filed on Feb. 12, 2015.

(51) Int. Cl. G06F 17/50; G06F 17/18; G06N 3/08

(52) U.S. Cl. CPC G06F 17/5009; G06N 3/08; G06F 17/18

(57) ABSTRACT

A method and system are provided. The method includes determining, by a processor, a set of battery aging modeling parameters that include battery capacity for a battery based on a statistical analysis applied to experiment data. The experiment data is obtained from measurements of a set of battery parameters that include battery capacity and that are taken by a hardware-based battery parameter monitoring device during a plurality of experiments which vary another set of battery parameters. The set and the other set have at least some different members. The method further includes generating, by the processor, a battery aging neural network based model for the battery that includes the set of battery aging modeling parameters. The method also includes storing the battery aging neural network based model in a memory device.

### RELATED APPLICATION INFORMATION

This application claims priority to provisional application Ser. No. 62/219,895 filed on Sep. 17, 2015, and to provisional application Ser. No. 62/115,258 filed on Feb. 12, 2015, both incorporated herein by reference.

### BACKGROUND

1. Technical Field

The present invention relates to energy storage, and more particularly to a data-driven battery aging model using statistical analysis and artificial intelligence.

2. Description of the Related Art

Batteries are essential tools for the safe and secure operation of microgrids (MGs). Additionally, batteries have recently attracted significant attention from researchers and developers for large-scale power system connected applications in frequency regulation, voltage support, demand charge minimization, and so forth. Although the different existing battery types (such as, but not limited to, Li-Ion) show a reducing trend in price, they are still considered as the most expensive entities of the system and application in which they reside. On the other hand, they suffer from deficiencies such as losing their initial capacity and power capability during their lifetime. As a result, their optimal operation by taking into account their degradation is very critical for successful implementation of such devices.

In order to account for battery degradation, it is required to estimate actual battery capacity as a result of a specific charge/discharge profile. To do so, an accurate battery degradation model is required. Battery degradation can be classified as “cycling” aging and “calendar” aging. Cycling aging occurs when a battery is under charge or discharge while calendar aging occurs when a battery remains idle. In an actual environment, both types of aging are equally important and should be captured by a degradation model.

Battery aging is a complex phenomenon involving many operational parameters. An accurate and fast battery aging model can improve the performance of battery sizing models and management systems significantly. Accordingly, different models have been proposed to estimate battery capacity degradation (i.e., aging). However, the proposed models typically simplify the problem by only including 1 to 3 parameters in their proposed model. Additionally, no evidence is given to support the hypotheses behind selecting some parameters while ignoring others. Furthermore, some of the proposed models are built upon very complicated chemical reactions of the battery which are computationally expensive and require many chemical parameters of the battery to be known. They usually are not a suitable choice for applications where fast battery aging estimation is required. Additionally, such approaches require detailed information about battery chemical materials and reactions to form the model which is generally not available in battery catalogs.

Thus, there is a need for an improved approach to generate a simple, fast, and accurate battery aging model.

### SUMMARY

These and other drawbacks and disadvantages of the prior art are addressed by the present principles, which are directed to a data-driven battery aging model using statistical analysis and artificial intelligence.

According to an aspect of the present principles, a method is provided. The method includes determining, by a processor, a set of battery aging modeling parameters that include battery capacity for a battery based on a statistical process applied to experiment data. The experiment data is obtained from measurements of a set of battery parameters that include battery capacity and that are taken by a hardware-based battery parameter monitoring device during a plurality of experiments which vary another set of battery parameters. The set and the other set have at least some different members. The method further includes generating, by the processor, a battery aging neural network based model for the battery that includes the set of battery aging modeling parameters. The method also includes storing the battery aging neural network based model in a memory device.

According to another aspect of the present principles, a battery management system is provided. The system includes a processor. The processor is for determining a set of battery aging modeling parameters that include battery capacity for a battery based on a statistical process applied to experiment data, and generating a battery aging neural network based model for the battery that includes the set of battery aging modeling parameters. The system further includes a memory for storing the set of battery aging modeling parameters. The experiment data is obtained from measurements of a set of battery parameters that include battery capacity and that are taken by a hardware-based battery parameter monitoring device during a plurality of experiments which vary another set of battery parameters. The set and the other set having at least some different members.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating an exemplary processing system 100 to which the present principles may be applied, according to an embodiment of the present principles;

FIG. 2 shows an exemplary system 200 for generating a data-driven battery aging model using statistical analysis and artificial intelligence, in accordance with an embodiment of the present principles;

FIG. 3 shows another exemplary system 300 for generating a data-driven battery aging model using statistical analysis and artificial intelligence, in accordance with an embodiment of the present principles;

FIG. 4 shows an exemplary environment 400 to which the present principles can be applied, in accordance with an embodiment of the present principles.

FIG. 5 shows an exemplary method 500 for generating a battery aging model for a battery, in accordance with an embodiment of the present principles; and

FIGS. 6-7 show another exemplary method 600 for generating a battery aging model for a battery, in accordance with an embodiment of the present principles.

### DETAILED DESCRIPTION OF PREFERRED EMBODIMENTS

The present principles are directed to a data-driven battery aging model using statistical analysis and artificial intelligence.

In an embodiment, the statistical significance of each parameter in a final battery aging model generated in accordance with the present principles is justified based on analytical (statistical) study. Then, different interaction (i.e., synergetic) terms among different parameters and their higher order behavior are hypothesized and later justified through statistical analysis techniques. The impact of a higher degree of operational parameters is investigated and found to be helpful to obtain higher accuracy in the model. A neural network battery aging model is then provided that can be conveniently used in any sizing and management studies as well as a myriad of other applications as readily appreciated by one of ordinary skill in the art. Additionally, it has the advantage of modeling the synergetic terms between input parameters as well as nonlinearity in the battery degradation phenomena.

Advantageously, the battery aging model provided in accordance with the present principles is very fast and computationally inexpensive for these types of applications. The battery aging model includes all important operational parameters of battery aging modeling in the same framework.

In an embodiment, a battery degradation model is developed using statistical analyses and neural network (NN) technique for cycling aging only.

In an embodiment, a battery degradation model is developed using statistical analyses and neural network (NN) technique for calendar aging as well.

The present principles can be applied to Lithium-Ion (Li-Ion) as well as other battery types, as readily appreciated by one of ordinary skill in the art, while maintaining the spirit of the present principles.

In an embodiment, the proposed battery aging model includes ambient temperature, the maximum and minimum state of charge (SOC) of the battery, charging and discharging rates, and energy throughput. The preceding five parameters have been determined by study to be statistically significant in a comprehensive and accurate battery aging modeling. Additionally, these parameters have interactive relations where changing one parameter not only affects battery capacity degradation, but can also change another parameter(s). In an embodiment, previous estimated battery capacity in both cycling and calendar aging, previous energy throughput in cycling aging and accumulative shelf time in calendar aging are also considered as input parameters. Statistical analyses proved their significance on a battery degradation model.

Of course, a battery aging model in accordance with the present principles is not limited to solely the preceding parameters and, thus, other parameters can also be used in accordance with the teachings of the present principles, while maintaining the spirit of the present principles. Moreover, the trained neural network can be easily and effectively ported to other battery aging related applications as readily appreciated by one of ordinary skill in the art given the teachings of the present principles provided herein, while maintaining the spirit of the present principles. The generation of the proposed battery aging model is fast and has incurs minimal computational efforts. Besides the neural network model, analytical approaches (i.e., statistical analyses) are utilized to develop other types of battery aging model with multiple regression and least square method.

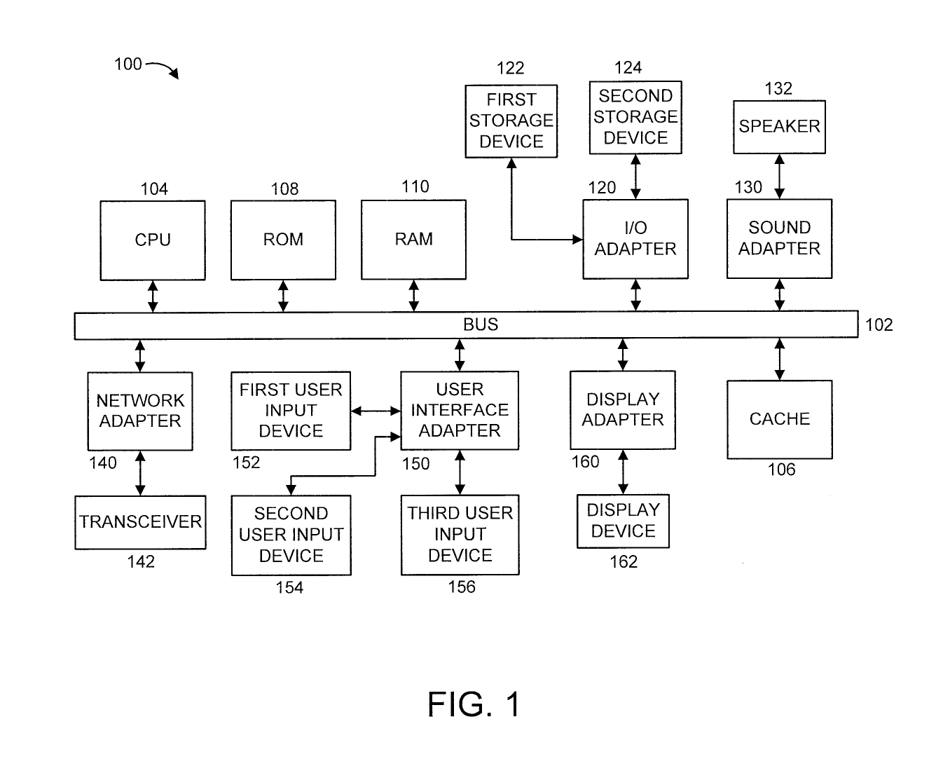

Referring now in detail to the figures in which like numerals represent the same or similar elements and initially to FIG. 1, a block diagram illustrating an exemplary processing system 100 to which the present principles may be applied, according to an embodiment of the present principles, is shown. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

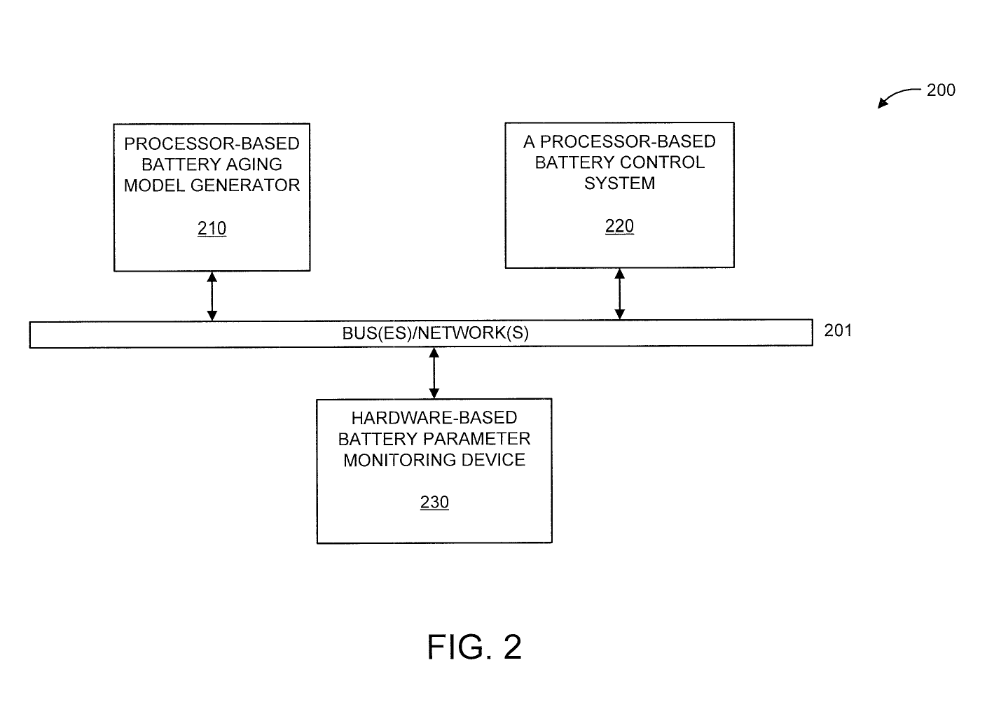

Moreover, it is to be appreciated that system 200 described below with respect to FIG. 2 is a system for implementing respective embodiments of the present principles. Part or all of processing system 100 may be implemented in one or more of the elements of system 200.

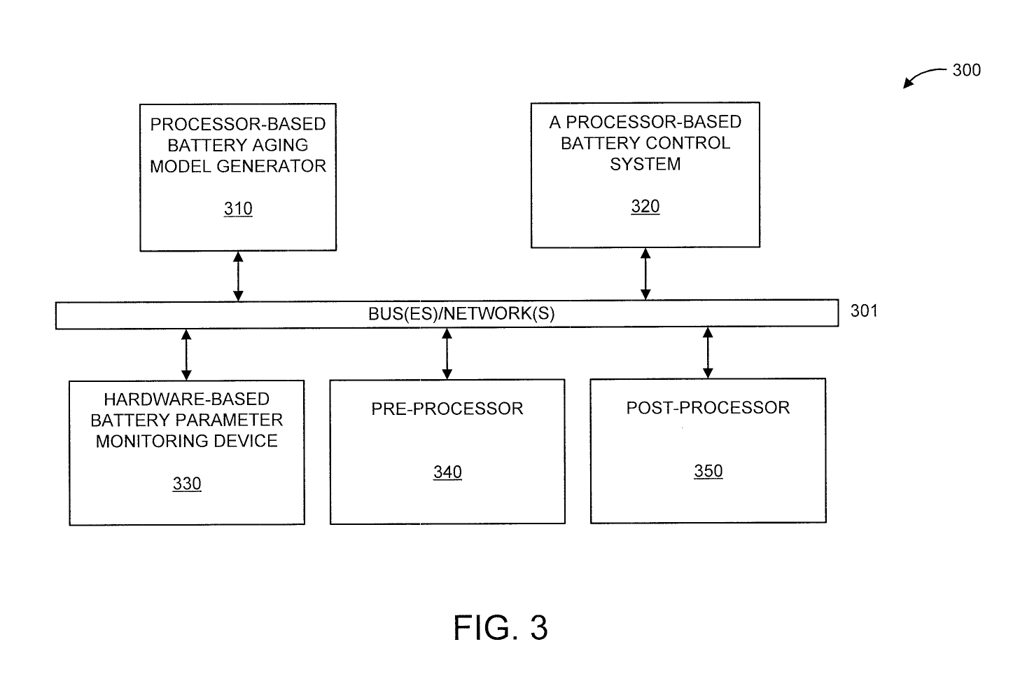

Also, it is to be appreciated that system 300 described below with respect to FIG. 3 is a system for implementing respective embodiments of the present principles. Part or all of processing system 100 may be implemented in one or more of the elements of system 300.

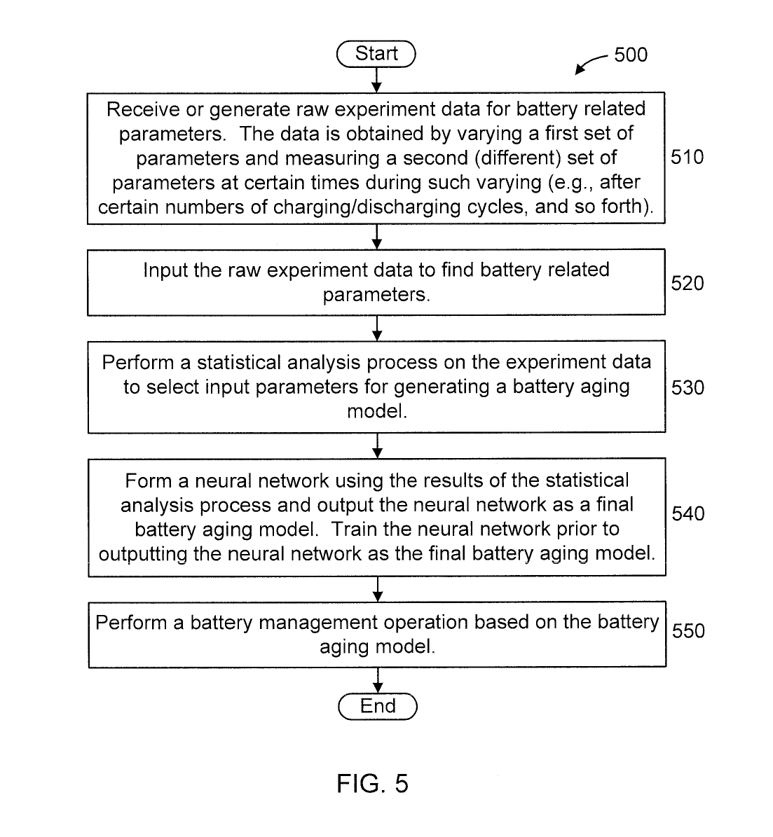

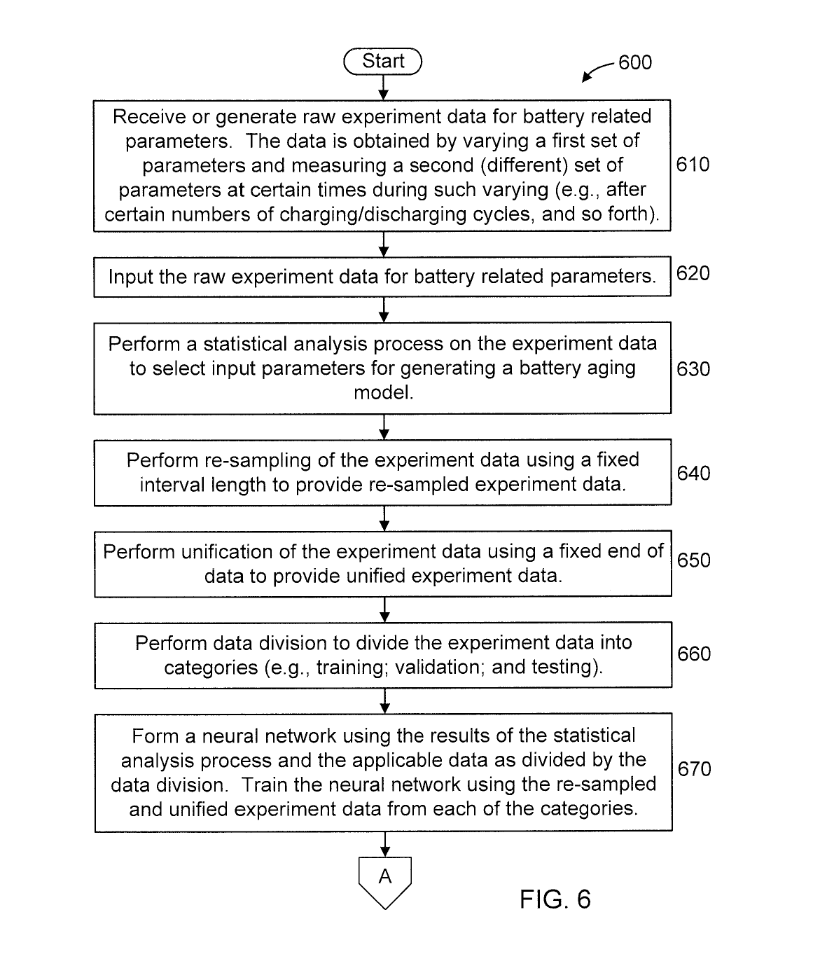

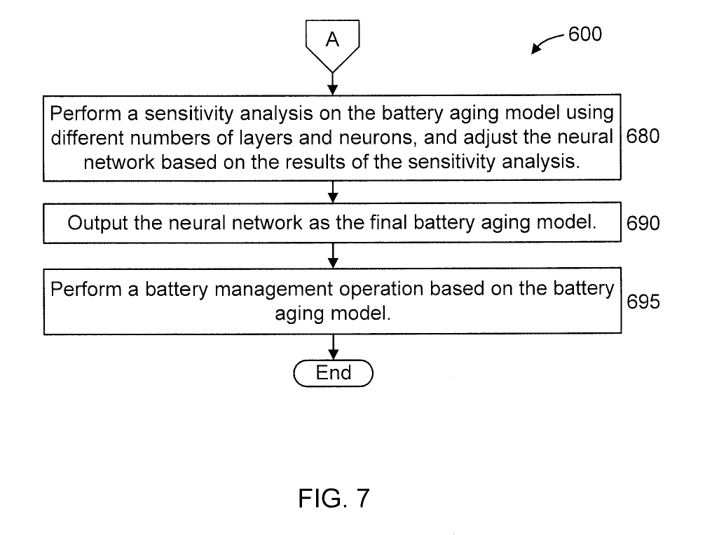

Further, it is to be appreciated that processing system 100 may perform at least part of the methods described herein including, for example, at least part of method 500 of FIG. 5 and/or at least part of method 600 of FIGS. 6-7. Similarly, part or all of system 200 may be used to perform at least part of method 500 of FIG. 5 and/or at least part of method 600 of FIGS. 6-7, and part or all of system 300 may be used to perform at least part of method 500 of FIG. 5 and/or at least part of method 600 of FIGS. 6-7.

FIG. 2 shows an exemplary system 200 for generating a data-driven battery aging model using statistical analysis and artificial intelligence, in accordance with an embodiment of the present principles. System 200 is directed to cycling aging and/or calendar aging, and can be used to perform method 500 of FIG. 5. Moreover, given the applications to which system 200 can be applied, system 200 can be interchangeably referred to as a battery management system.

The system 200 includes a processor-based battery aging model generator 210, a processor-based battery control system 220, and a hardware-based battery parameter monitoring device 230. The processor-based battery control system 220 is enabled to perform energy management functions and, thus, the terms “processor-based battery control system” and “energy management system” are used interchangeably herein.

The processor-based battery aging model generator 210 generates a battery aging model as described herein (e.g., with respect to FIG. 5).

The processor-based battery control system 220 interfaces with the system in which the modeled battery is deployed. The processor-based battery control system 220 performs actions responsive to the model generated by the processor-based battery aging model generator 210.

For example, actions performed by the processor-based battery control system 220 can include, but are not limited to, providing a warning/indication to one or more personnel and/or to the power system in which the modeled battery is used (e.g., to initiate the personnel and/or power system to take an action in response to the model, and so forth), performing a battery management operation, providing long-term planning direction and economical operation and analysis based on how battery is operated, and so forth. It is to be appreciated that the processor-based battery control system 220 can perform any type of energy management function including, but not limited to, setting and/or changing a charge/discharge profile of a battery.

The aforementioned warning/indication can be provided via, for example, but not limited to, email, text, a visual-based indicator, a tactile-based indicator, a sound-based indicator, and so forth. The visual-based indicator can be, for example, but is not limited to, a flashing light (located in a place in which applicable personnel can see the light and act upon the indication that its use provides), and so forth. The tactile-based indicator can be, for example, but is not limited to, a vibration generating device (e.g., as found in many mobile phones and pagers), and so forth. The sound-based indicator can be, for example, but is not limited to, a speaker, and so forth.

The battery management operation can include, but is not limited to, switching and/or otherwise initiating a switching from one battery (e.g., that the model has indicated and/or otherwise identified as being near its end-of-life or having some other aging related deficiency as determined by the model (e.g., loss of capacity greater than a threshold amount, and so forth) to another that is in better condition (e.g., a new or newer battery, a battery having a different capacity and/or size, and so forth), and so forth. The switching from one battery to another can be made through one or more hardware-based switches (e.g., relays) that are controlled by the processor-based battery control system 220 and/or are responsive to a command initiated by the processor-based battery control system 220.

The preceding actions that can be taken by the processor-based battery control system 220 are merely illustrative and, thus, other actions can also be performed by the processor-based battery control system 220 as readily appreciated by one of ordinary skill in the art given the teachings of the present principles provided herein, while maintaining the spirit of the present principles.

The hardware-based battery parameter monitoring device 230 monitors (e.g., measures) certain battery parameters used to generate a battery aging model in accordance with the present principles. The battery parameters can include, but are not limited to, any of the following: temperature; charging/discharging rates; maximum/minimum state of charge (SOC); energy throughput; accumulative shelf time; battery capacity; internal resistance; terminal voltage; internal temperature; and so forth. The hardware-based battery parameter monitoring device 230 can read battery charge/discharge profiles and provide the profiles to the battery aging model generator 210 in order for the generator 210 to estimate battery degradation. The processor-based battery control system 220 can set a new charge/discharge profile or change a current charge/discharge profile to a different charge/discharge profile based on a battery aging model generated in accordance with the present principles.

FIG. 3 shows another exemplary system 300 for generating a data-driven battery aging model using statistical analysis and artificial intelligence, in accordance with an embodiment of the present principles. System 300 is directed to cycling aging and/or calendar aging, and can be used to perform method 600 of FIGS. 6-7. Moreover, given the applications to which system 300 can be applied, system 300 can be interchangeably referred to as a battery management system.

The system 300 includes a processor-based battery aging model generator 310, a processor-based battery controller 320, and a hardware-based battery parameter monitoring device 330. The processor-based battery aging model generator 310, processor-based battery controller 320, and hardware-based battery parameter monitoring device 330 respectively operate similarly to the processor-based battery aging model generator 210, processor-based battery controller 220, and hardware-based battery parameter monitoring device 230 shown and described with respect to FIG. 2 and, thus, descriptions of their functions will not be repeated here for the sake of brevity.

System 300 further includes a pre-processor 340 and a post-processor 350.

In an embodiment, the pre-processor 340 performs functions that include, for example, but are not limited to, re-sampling and unification.

Re-sampling of the raw experiment data that serves as an input to method 600 is performed since those values are measured at different intervals. Even in a single experiment, battery capacity measurement intervals are not the same. A trained neural network will learn each individual trend in the data but may not be able to generalize the characteristics in the data. The performance of the neural network may not be optimal when new data other than training data is used for testing.

Additionally, the test data resolution might be different which again can amplify the error in battery aging estimation. As a result, re-sampling the data with a fixed interval length can improve the training procedure and, consequently, the accuracy of the resultant battery aging model. To do so, we have developed a method to re-sample the raw experiment data. For each experiment, we first find the minimum interval, and then the maximum interval of those minimum intervals calculated from different experiments will be the fixed interval of all experimental data, as represented by the following Equation (1):

max(min(Interval of Eᵢ)) (1)

where Ei denotes experiment i. After selecting the fixed interval, every experiment will be re-sampled using linear interpolation. Based on the available experiment data, linear interpolation has been found to adequately represent the trend in data between each two points in the original data. This can be replaced by higher-order functions in the case of more nonlinear data.

Another potential issue in the original experiment data is the fact that the end of the data (i.e., final W·h throughput, where “W·h” denotes the amount of energy which has been stored in or extracted from battery over an hour) is different in various experiments. That is, some of the experiments might include more information than other experiments. Since the neural network can be trained for all data at the same time, learning information and trends in some data and not others may deteriorate subsequent performance of the neural network. To avoid this, it has been determined that a better result is obtained by defining a maximum W·h throughput for each experiment during training and testing. We first find the maximum W·h throughput measured for each experiment separately. The maximum W·h throughput for all experiments is the smallest value among individual experiments as represented by the following Equation (2):

min(max(W·h_{Ei}) (2)

The rest of the data in each experiment can be ignored. In an embodiment, the same approach is used for calendar aging except that W·h throughput is replaced with battery accumulative shelf time in days (accumulative number of days during which the battery has been idle since its installation). It is to be noted that the trained neural network model will be utilized when any new data is re-sampled and unified based on the values that are used to train the model.

The pre-processor 340 can also perform data division for neural network training. That is, the pre-processor 340 can be used to divide the data into categories in preparation for neural network training.

In further detail, the preparation of data for use in neural network training can involve dividing available data into the following three categories: training; validation; and testing. The appropriate dividing of input data for neural network training can serve to improve the performance of the trained battery aging model.

It is to be appreciated that battery degradation changes over the time. For example, battery degradation for the same charge/discharge profile at the beginning of its life is much less than its degradation some time later. Therefore, a data division method is provided where the experiment data is categorized in a way to represent the overall characteristics of the experiment data. To do so, a sliding window categorization is implemented where two samples from every three samples will be labeled as a “training” dataset, while the one remaining sample of each window will be labeled as a “validation” dataset and a “testing” dataset for every other (third) one. An example is as follows:

1^{st} sample=training dataset;

2^{nd} sample=validation dataset;

3^{rd} sample=training dataset;

4^{th} sample=training dataset;

5^{th} sample=testing dataset; and

6^{th} sample=training dataset.

Hence, more data is devoted to the “training” datasets, which is reasonable and normal in neural network training. This approach, though simple, guarantees that each category will have samples from all over the space of the data.

The post-processor 350 checks the accuracy of the battery aging model with different numbers of layers and neurons using a sensitivity analysis.

The reasoning behind the functions performed by the post-processor 350 will now be described.

Neural network training is highly dependent on the data and structure of the neural network itself. There are different parameters which can affect the performance of the neural network in training and testing. Some significant parameters include, for example, the number of hidden layers in each layer and the number of hidden neurons in each layer.

Accordingly, a sensitivity analysis is performed on the number of hidden layers and the number of hidden neurons to find an appropriate and optimal neural network structure. The sensitivity analysis tries different numbers of hidden layers and neurons in each layer and compares the results for a “testing” dataset to find the best (optimal) structure. The best structure in our method is determined by the one with highest R-squared value for a “testing” dataset. If two neural network structures have a similar R-squared value, then the neural network structure with the least mean absolute error (MSE) in the “testing” dataset is chosen.

In the embodiments shown in FIGS. 2 and 3, the respective elements thereof are interconnected by a bus(es)/network(s) 201 and 301, respectively. However, in other embodiments, other types of connections can also be used. Further, while one or more elements may be shown as separate elements, in other embodiments, these elements can be combined as one element. The converse is also applicable, where while one or more elements may be part of another element, in other embodiments, the one or more elements may be implemented as standalone elements. Moreover, one or more elements in any of FIG. 2 and/or FIG. 3 may be implemented by a variety of devices, which include but are not limited to, Digital Signal Processing (DSP) circuits, programmable processors, Application Specific Integrated Circuits (ASICs), Field Programmable Gate Arrays (FPGAs), Complex Programmable Logic Devices (CPLDs), and so forth. These and other variations of the elements of system 200 and system 300 are readily determined by one of ordinary skill in the art, given the teachings of the present principles provided herein, while maintaining the spirit of the present principles.

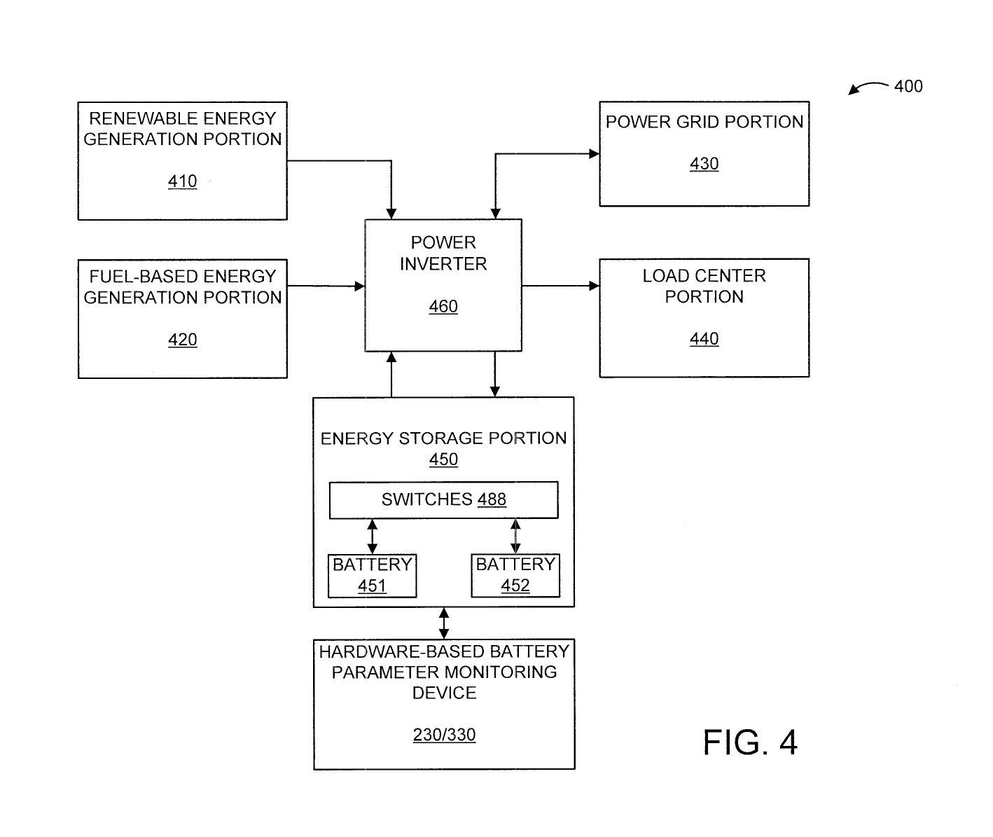

FIG. 4 shows an exemplary environment 400 to which the present principles can be applied, in accordance with an embodiment of the present principles.

The environment 400 includes a renewable energy generation portion 410, a fuel-based energy generation portion 420, a power grid portion 430, a load center portion 440, an energy storage portion 450, and an inverter 460.

The renewable energy generation portion 410 can include, for example, but is not limited to, wind-based power generators, solar-based power generators, and so forth.

The fuel-based energy generation portion 420 can include, for example, but is not limited to, generators powered by fuel (gasoline, propane, etc.), and so forth.

The power grid portion 430 provides the structure for conveying power (e.g., to local and/or remote locations).

The load center 440 is a consumer of the power and can be a facility, a region, and/or any entity that provides a load for the power.

The energy storage portion 450 can include one or more energy storage devices such as batteries that can be modeled in accordance with the present principles. Batteries are typically employed in a MG or in power system for frequency regulation, demand response and demand charge, load shifting, and so on. As it is shown in FIG. 4, an energy storage device can either be charged or discharged in the power system. Battery degradation is directly affected by its charge/discharge profile and the time which the battery is idle.

Hardware-based switches 488 can be used to switch from one battery 451 to another battery 452 depending upon and responsive to the results of a battery aging model generated in accordance with the present principles.

The inverter 460 performs Direct Current (DC) to Alternating Current (AC) conversion.

The systems 200 and 300 can interface with environment 400 (as shown and described with respect to FIG. 4) in order to model the batteries 451 and 452 in the energy storage portion 450 and can perform actions implemented by and/or within the environment 400. In the embodiment of FIG. 4, a hardware-based battery parameter monitoring device (e.g., element 230 or element 330 from FIGS. 2 and 3, respectively) interfaces with the energy storage portion 450.

FIG. 5 shows an exemplary method 500 for generating a battery aging model for a battery, in accordance with an embodiment of the present principles. Method 500 is directed to battery cycling aging and/or calendar aging.

At step 510, receive or generate raw experiment data for battery related parameters. The data is obtained by varying a first set of parameters and measuring a second (different) set of parameters at certain times during such varying (e.g., after certain numbers of charging/discharging cycles, and so forth).

For calendar aging, in an embodiment, the first set of parameters can include, but are not limited to, one or (preferably) more of the following: battery storage SOC; ambient temperature; previous estimated battery capacity; and accumulative shelf time. For calendar aging, in an embodiment, the second set of parameters can include, but are not limited to, one or (preferably) more of the following: battery capacity; internal impedance; internal temperature; terminal voltage; and state-of-health (SOH).

For battery cycling aging, in an embodiment, the first set of parameters can include, but are not limited to, one or (preferably) more of the following: charging and discharging rates; maximum and minimum SOC; ambient temperature; previous estimated battery capacity; and W·h throughput. For battery cycling aging, in an embodiment, the second set of parameters can include, but are not limited to, one or (preferably) more of the following: battery capacity; internal impedance; internal temperature; terminal voltage; and state-of-health (SOH).

It is to be appreciated that the data includes multiple values for each of the first set of parameters and the corresponding values that result for the second set of parameters.

At step 520, input the raw experiment data to find battery related parameters.

At step 530, perform a statistical analysis process on the experiment data to select input parameters for generating a battery aging model.

The selection at step 530 is performed so as to select the most significant parameters in the experiments that are to be included in the model.

In an embodiment, step 530 can involve single and multiple regressions using a least square technique. For example, in an embodiment, K-fold cross-validation is used to correctly determine the test error and select the best model parameters. In an embodiment, interactive and higher order terms are hypothesized and verified using null hypothesis (p-values based on t-statistics).

In an embodiment, step 530 can involve using Ridge and Lasso regressions to verify the results from the least squares and to improve training for the model that is ultimately generated from the parameters selected at step 530.

At step 540, form a neural network using the results of the statistical analysis process and output the neural network as a final battery aging model.

In an embodiment, step 540 includes training the neural network prior to outputting the neural network as the final battery aging model.

At step 550, perform a battery management operation based on the battery aging model.

In an embodiment, the data used by step 510 can be placed into three general categories as follows: training; validation; and testing.

Thus, in method 500, the experiment data is directly used for statistical analysis, where the output/results from such statistical analysis include appropriate input parameters for effective modeling of battery degradation. Method 500 does not involve and pre-processing or post-processing activities in order to generate a battery aging model.

A description will now be given regarding another method (as described with respect to FIGS. 6-7) for generating a battery aging model.

The statistical analyses and neural network (NN) based method 500 of FIG. 5 is further improved over the prior art by adding new features (such as re-sampling and unifying data samples, a technique to divide experiment data for NN training and testing, and a sensitivity analysis for finding the best NN structure) and processing based on actual battery operation in the power systems. Additionally, the method 600 shown in FIGS. 6-7 can be advantageously used for calendar degradation modeling with a different set of input parameters.

FIGS. 6-7 show another exemplary method 600 for generating a battery aging model for a battery, in accordance with an embodiment of the present principles. Method 600 is directed to calendar aging and/or cycling aging.

At step 610, receive or generate raw experiment data for battery related parameters. The data is obtained by varying a first set of parameters and measuring a second (different) set of parameters at certain times during such varying (e.g., after certain numbers of charging/discharging cycles, and so forth).

For calendar aging, in an embodiment, the first set of parameters can include, but are not limited to, one or (preferably) more of the following: battery storage SOC; ambient temperature; previous estimated battery capacity; and accumulative shelf time. For calendar aging, in an embodiment, the second set of parameters can include, but are not limited to, one or (preferably) more of the following: battery capacity; internal impedance; internal temperature; terminal voltage; and state-of-health (SOH).

For battery cycling aging, in an embodiment, the first set of parameters can include, but are not limited to, one or (preferably) more of the following: charging and discharging rates; maximum and minimum SOC; ambient temperature; previous estimated battery capacity; and W·h throughput. For battery cycling aging, in an embodiment, the second set of parameters can include, but are not limited to, one or (preferably) more of the following: battery capacity; internal impedance; internal temperature; terminal voltage; and state-of-health (SOH).

It is to be appreciated that the data includes multiple values for each of the first set of parameters and the corresponding values that result for the second set of parameters.

At step 620, input the raw experiment data for battery related parameters.

At step 630, perform a statistical analysis process on the experiment data to select input parameters for generating a battery aging model.

The selection at step 630 is performed so as to select the most significant parameters in the experiments that are to be included in the model.

In an embodiment, step 630 can involve single and multiple regressions using a least square technique. For example, in an embodiment, K-fold cross-validation is used to correctly determine the test error and select the best model parameters. In an embodiment, interactive and higher order terms are hypothesized and verified using null hypothesis (p-values based on t-statistics).

In an embodiment, step 630 can involve using Ridge and Lasso regressions to verify the results from the least squares and to improve training for the model that is ultimately generated from the parameters selected at step 630.

At step 640, perform re-sampling of the experiment data using a fixed interval length to provide re-sampled experiment data. The re-sampling unifies the sampling rate among all experiments. In particular, each experiment performed to provide the experiment data is evaluated to determine the respective minimum intervals for each (or a subset) of the experiments, and the maximum interval from among the determined minimum intervals is used as a fixed interval for all of the experiment data. The experiment data is then re-sampled using the fixed interval.

At step 650, perform unification of the experiment data using a fixed end of data (W·h throughput and battery shelf time for cycling and calendar aging, respectively) to provide unified experiment data. The unification unifies the end of samples among all experiments. In particular, the maximum W·h throughput and battery shelf time for cycling and calendar aging, respectively, of each of the experiments is determined, and the minimum from among the determined maximum values is used as a maximum W·h throughput and battery shelf time limit in cycling and calendar aging modeling, respectively, for all of the experiments.

At step 660, perform data division to divide the experiment data into categories. The experiment data are divided into the following three categories: training; validation; and testing. These are standard categories of data required for neural network training, validation, and testing.

At step 670, form a neural network using the results of the statistical analysis process and the applicable data as divided by the data division.

In an embodiment, step 670 includes training the neural network. The training will use the re-sampled and unified experiment data from each of the aforementioned categories. Neural network training involves three steps, where the first two steps are performed simultaneously, and the third step is performed at the end of training. The first two steps are training and validation. In these steps, the training algorithm of the training step tries to estimate weights and biases values of the function while the performance is evaluated constantly in the validation step. If validation fails for several consecutive steps, training is considered complete. Then, testing is carried out to ensure that the trained neural network is generalized and patterns are captured. In this way, all three categories of data (namely training, validation, and testing) will always be utilized during NN Training.

At step 680, perform a sensitivity analysis on the battery aging model using different numbers of layers and neurons, and adjust the neural network based on the results of the sensitivity analysis.

At step 690, output the neural network as the final battery aging model.

At step 695, perform a battery management operation based on the battery aging model.

When battery degradation estimation is available, as provided by the model, it is possible to change the battery charge/discharge profile for a given battery so that the battery can last for a certain number of years or operate economically considering its degradation and initial costs. To that end, a battery degradation estimate can be generated for one or more particular profiles. This will assist in observing the battery's degradation during the battery's operation and rendering smart decisions about the battery's operation.

A description will now be given regarding the specific competitive/commercial value of the solution achieved by the present principles.

Advantageously, the present principles generate a battery aging model with less complexity and with faster operation. Implementing this model in real-world applications (such as energy management systems for battery) incurs little cost while providing a significant degree of accuracy, particularly over prior art approaches.

As appreciated by one of ordinary skill in the art, there are many parameters affecting battery aging. The present principles provide a method that captures the most significant parameters of battery aging with statistical techniques. The statistical significance of different interactions among these parameters and their higher order behavior are recognized within the statistical analysis framework. Then, a neural network model of battery aging is developed with all significant parameters in the battery aging process.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of” for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method, comprising:
determining, by a processor, a set of battery aging modeling parameters that include battery capacity for a battery based on a statistical process applied to experiment data, the experiment data obtained from measurements of a set of battery parameters that include battery capacity and that are taken by a hardware-based battery parameter monitoring device during a plurality of experiments which vary another set of battery parameters, the set and the other set having at least some different members;
generating, by the processor, a battery aging neural network based model for the battery that includes the set of battery aging modeling parameters; and
storing the battery aging neural network based model in a memory device.

2. The method of claim 1, wherein the set of battery parameters further include at least one of an internal resistance, a terminal voltage, state of health, and an internal temperature.

3. The method of claim 1, wherein the battery aging neural network based model is a battery cycling degradation model, and the other set of battery parameters comprise at least two of an ambient temperature, a charging rate, a discharging rate, a minimum state of charge, a maximum state of charge, previous estimated battery capacity, and an energy storage or extraction throughput.

4. The method of claim 1, wherein the battery aging neural network based model is a calendar aging degradation model, and the other set of battery parameters comprise at least two of a state of charge of the battery at the beginning of an idle situation), an ambient temperature, an accumulative shelf time, and a previous estimated battery capacity.

5. The method of claim 1, wherein the statistical process uses a statistical analysis applied to the experiment data to determine the set of battery aging modeling parameters based on statistical significance.

6. The method of claim 5, wherein the statistical significance is based on different interactions between the battery parameters in at least one of the set and the other set.

7. The method of claim 1, wherein the statistical process comprises applying single and multiple regressions with a least squares process to the experiment data.

8. The method of claim 7, wherein Ridge and Lasso regressions are used to verify results obtained from the least squares process.

9. The method of claim 7, wherein the statistical process uses k-fold cross-validation to determine a test error and select the set of battery aging model parameters.

10. The method of claim 1, further comprising setting or changing a charging/discharging profile for the battery based on the battery aging neural network based model.

11. The method of claim 1, further comprising initiating a switching, using one or more hardware based switches, from the battery to another battery based on a battery aging related prediction derived from the battery aging neural network based model.

12. The method of claim 1, further comprising:
re-sampling the experiment data obtained from each of the plurality of experiments using a fixed interval length to obtain re-sampled experiment data; and
training the battery aging neural network based model using the re-sampled experiment data,
wherein the fixed interval length is determined as a maximum one of respective minimum intervals for the plurality of experiments.

13. The method of claim 1, further comprising:
performing a unification process on the experiment data using a fixed end of data to obtain unified experiment data; and
training the battery aging neural network based model using the unified experiment data,
wherein the fixed end of data is determined as a minimum one of respective maximum data throughputs for the plurality of experiments.

14. The method of claim 1, further comprising:
performing a data division operation on the experiment data to divide the experiment data into a training category, a validation category, and a testing category; and
training the battery aging neural network based model using the experiment data categorized into each of the training category, the validation category, and the testing category,
wherein the data division operation categories more of the experiment data into the training category than the validation category and the testing category.

15. The method of claim 1, further comprising:
performing an sensitivity analysis on the battery aging neural network based model using different numbers of layers and different numbers of neurons; and
adjusting the battery aging neural network based model based on results of the sensitivity analysis.

16. A non-transitory article of manufacture tangibly embodying a computer readable program which when executed causes a computer to perform the steps of claim 1.

17. A battery management system, comprising:
a processor for determining a set of battery aging modeling parameters that include battery capacity for a battery based on a statistical process applied to experiment data, and generating a battery aging neural network based model for the battery that includes the set of battery aging modeling parameters; and
a memory for storing the set of battery aging modeling parameters,
wherein the experiment data is obtained from measurements of a set of battery parameters that include battery capacity and that are taken by a hardware-based battery parameter monitoring device during a plurality of experiments which vary another set of battery parameters, the set and the other set having at least some different members.

18. The battery management system of claim 17, wherein the statistical process uses a statistical analysis applied to the experiment data to determine the set of battery aging modeling parameters based on statistical significance.

19. The battery management system of claim 18, wherein the statistical significance is based on different interactions between the battery parameters in at least one of the set and the other set.

20. The battery management system of claim 17, further comprising setting or changing a charging/discharging profile for the battery based on the battery aging neural network based model.
